(19) United States
(12) Patent Application Publication
(10) Pub. No.: US 2011/0249435 A1
(43) Pub. Date: Oct. 13, 2011

(54) LENS SYSTEM FOR AN LED LUMINAIRE

(75) Inventors: Pavel JURIK, Postredni Becva (CZ); Josef Valchar, Postredni Becva (CZ)

(73) Assignee: ROBE LIGHTING S.R.O.

(21) Appl. No.: 13/052,088

(22) Filed: Mar. 20, 2011

Related U.S. Application Data
(60) Provisional application No. 61/316,335, filed on Mar. 22, 2010.

(51) Int. Cl. F21V 5/04; F21V 7/00

(52) U.S. Cl. 362/235

(57) ABSTRACT

Disclosed is an LED light sourced automated luminaire with an achromatic beam angle zoom lens.

### RELATED APPLICATION

This application is a utility filing claiming priority of provisional application 61/316,335 filed on 22 Mar. 2010.

### TECHNICAL FIELD OF THE INVENTION

The present invention generally relates to an automated luminaire, specifically to an optical system for a luminaire utilizing an LED light source.

### BACKGROUND OF THE INVENTION

Luminaires with automated and remotely controllable functionality are well known in the entertainment and architectural lighting markets. Such products are commonly used in theatres, television studios, concerts, theme parks, night clubs and other venues. A typical product will typically provide control over the pan and tilt functions of the luminaire allowing the operator to control the direction the luminaire is pointing and thus the position of the light beam on the stage or in the studio. This position control is often done via control of the luminaire's position in two orthogonal rotational axes usually referred to as pan and tilt. Many products provide control over other parameters such as the intensity, color, focus, beam size, beam shape and beam pattern. Additionally it is becoming common to utilize high power LEDs as the light source in such luminaires and, for color control, it is common to use an array of LEDs of different colors. For example a common configuration is to use a mix of Red, Green and Blue LEDs. This configuration allows the user to create the color they desire by mixing appropriate levels of the three colors. For example illuminating the Red and Green LEDs while leaving the Blue extinguished will result in an output that appears Yellow. Similarly Red and Blue will result in Magenta and Blue and Green will result in Cyan. By judicious control of the LED controls the user may achieve any color they desire within the color gamut set by the LED colors in the array. More than three colors may also be used and it is well known to add an Amber or White LED to the Red, Green and Blue to enhance the color mixing and improve the gamut of colors available. The products manufactured by Robe Show Lighting such as the REDWash 3.192 are typical of the art.

FIG. 1 illustrates a typical multiparameter automated LED luminaire system. These systems commonly include a plurality of multiparameter automated luminaires 12, 14, 16 which typically each contain on-board an array of LEDs, and electric motors coupled to mechanical drives systems and control electronics (not shown). In addition to being connected to mains power either directly or through a power distribution system (not shown), each luminaire is connected is series or in parallel to data link 11, 13, 15 to one or more control desks 10. The luminaire system is typically controlled by an operator through the control desk 10. Consequently to effect this control both the control desk 10 and the individual luminaires typically include electronic circuitry as part of the electromechanical control system for controlling the automated lighting parameters.

FIG. 2 illustrates the output panel of a prior art LED automated luminaire 22. A panel 20 contains an array of LEDs 24 which emit light. In the case illustrated the LEDs 24 are in three colors, red (R), green (G) and blue (B). Each of the LED emitters 24 may emit light at a fixed beam angle. In further prior art devices each LED emitter 24 is fitted with an output optical system which allows changes in beam angle of the output. These systems are both limited in their zoom range and suffer from chromatic aberration in the optical systems such that the final size of the beams of each color are different. For example, the beam from the red LEDs may be larger than that from the blue resulting in a red halo around the edge of the combined beam.

FIGS. 3 and 4 illustrate an optical system used in the prior art to provide a variable beam angle or zoom to an automated LED luminaire. Each LED 50 which may be fitted with a primary optic 52 has an associated pair of lenses 53 and 55. Lenses 53 and 55 may be separate lenses or each part of an array of lenses covering the entire LED array. Lenses 53 and 55 may each comprise a single optical element 56 and 57 respectively. In operation at least one of lens 53 or lens 55 is stationary with respect to LED 50 while the other may move along optical axis 59. In the example illustrated in FIG. 3 and FIG. 4 lens 55 is fixed relative to LED 50 while lens 53 is able to move along optical axis 59. FIG. 3 shows lens 53 in a first position and FIG. 4 shows lens 53 in a second position closer to LED 50. This varying relative position between LED 50, lens 53 and lens 55 provides a beam angle or zoom to the light beam from LED 50.

There is a need for an optical zoom system for an LED automated luminaire with improved zoom range and reduced chromatic aberration.

### BRIEF DESCRIPTION OF THE DRAWINGS

For a more complete understanding of the present invention and the advantages thereof, reference is now made to the following description taken in conjunction with the accompanying drawings in which like reference numerals indicate like features and wherein:

FIG. 1 illustrates a typical automated LED lighting system;

FIG. 2 illustrates the front panel of an LED luminaire system;

FIG. 3 illustrates optical components of a prior art LED luminaire;

FIG. 4 illustrates optical components of a prior art LED luminaire;

FIG. 5 illustrates optical components of an embodiment of the disclosed LED luminaire;

FIG. 6 illustrates optical components of an embodiment of the disclosed LED luminaire;

FIG. 7 illustrates the front panel of an embodiment of the disclosed LED luminaire;

FIG. 8 illustrates an embodiment of the optical components illustrated in FIG. 5 and FIG. 6; and

FIG. 9 illustrates an alternative embodiment of the optical component illustrated in FIG. 5 and FIG. 6.

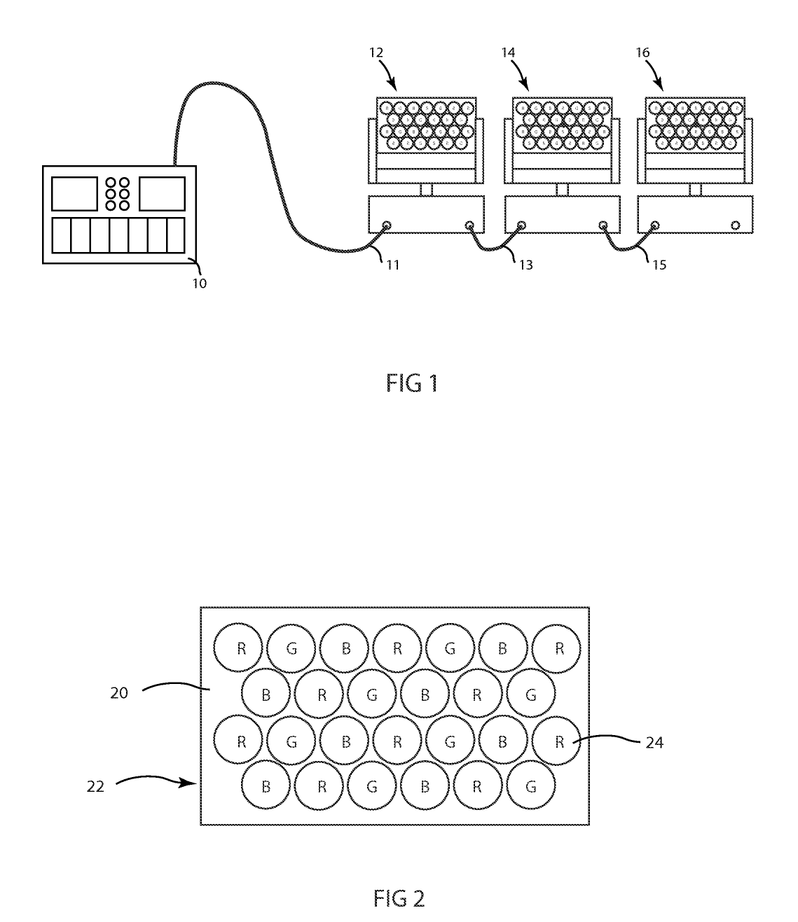

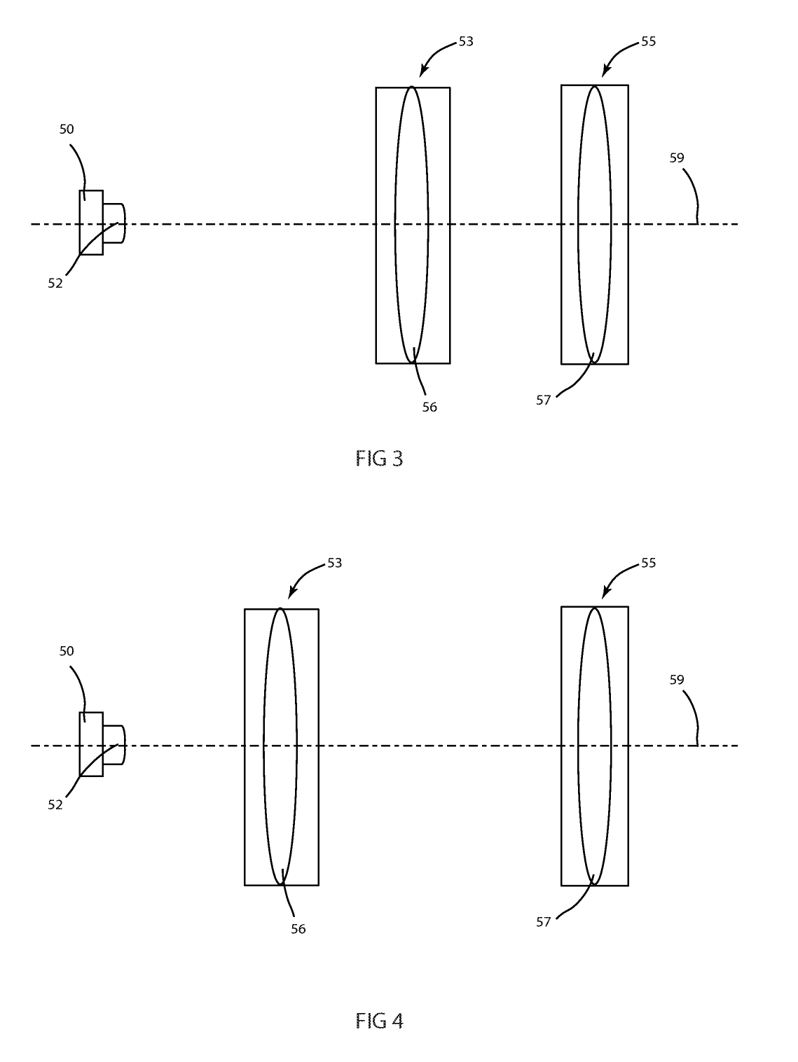

### DETAILED DESCRIPTION OF THE INVENTION

Preferred embodiments of the present invention are illustrated in the FIGURES, like numerals being used to refer to like and corresponding parts of the various drawings.

The present invention generally relates to an automated luminaire, specifically to an optical system for a luminaire utilizing an LED light source.

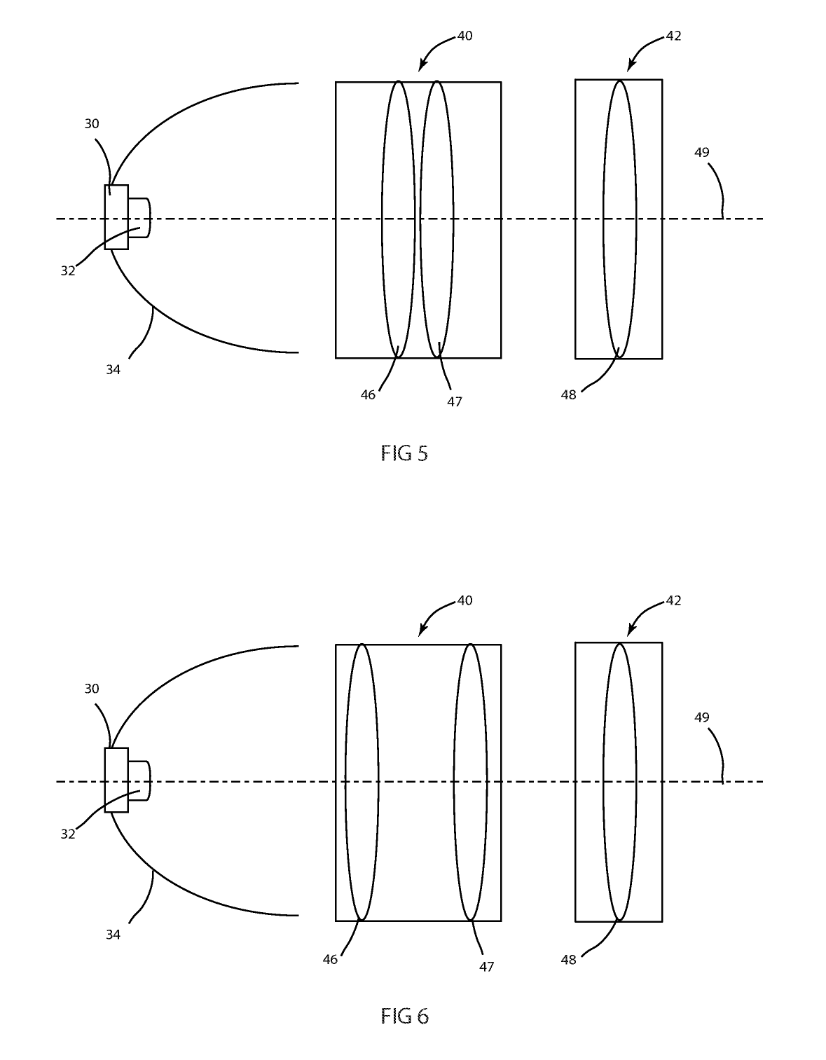

FIGS. 5 and 6 illustrate an optical system used in an embodiment of the invention to provide an improved variable beam angle or zoom to an automated LED luminaire. Each LED 50 which may be fitted with a primary optic 32 may be mounted within an elliptical reflector 34. Reflector 34 serves to collect light from LED 30 and direct it towards lens system 40 and lens system 42. Lens system 40 contains two or more optical elements 46 and 47. After passing through lens system 40 the light will pass through fixed output lens 42. Output lens 42 may contain one or more optical elements 48. Optical elements 46, 47 and 48 are illustrated herein as bi-convex lenses however the invention is not so limited and elements 46, 47 and 48 may be any optical element as well known in the art.

In operation output lens system 42 is fixed in position along optical axis 49 relative to LED 30 while either one or a plurality of optical elements 46 and 47 contained in lens system 40 may be free to move along optical axis 49 relative to LED 30 and output lens system 42. Optical elements 46 and 47 are chosen such that varying their position along optical axis 49 in conjunction with fixed output lens provides a beam angle or zoom to the light beam from LED 30. FIG. 5 shows lens elements 46 and 47 in first positions and FIG. 6 shows lens elements 46 and 47 in second positions relative to LED 30. The positions of lens elements 46 and 47 in FIG. 6 relative to each other and to fixed LED 30 and fixed output lens 42 provides a beam angle or zoom that differs from that provided by the positions of lens elements 46 and 47 in FIG. 5.

The optical properties of lens elements 46, 47 and 48 may be chosen such that the combined optical path is achromatic and provides the same degree of beam angle change to long wavelength, red, light as it does to short wavelength, blue, light and thus avoids chromatic aberration. This ensures that the beam from the red LEDs, green LEDs and blue LEDs are all the same size resulting in a uniformly colored combined beam.

Although the figures illustrate three colors of LEDs, red, green, and blue, the invention is not so limited and any number of colors of LEDs may be used without departing from the spirit of the invention. For example a system may use five different color LEDs such as red, green blue, amber and white or any combination thereof.

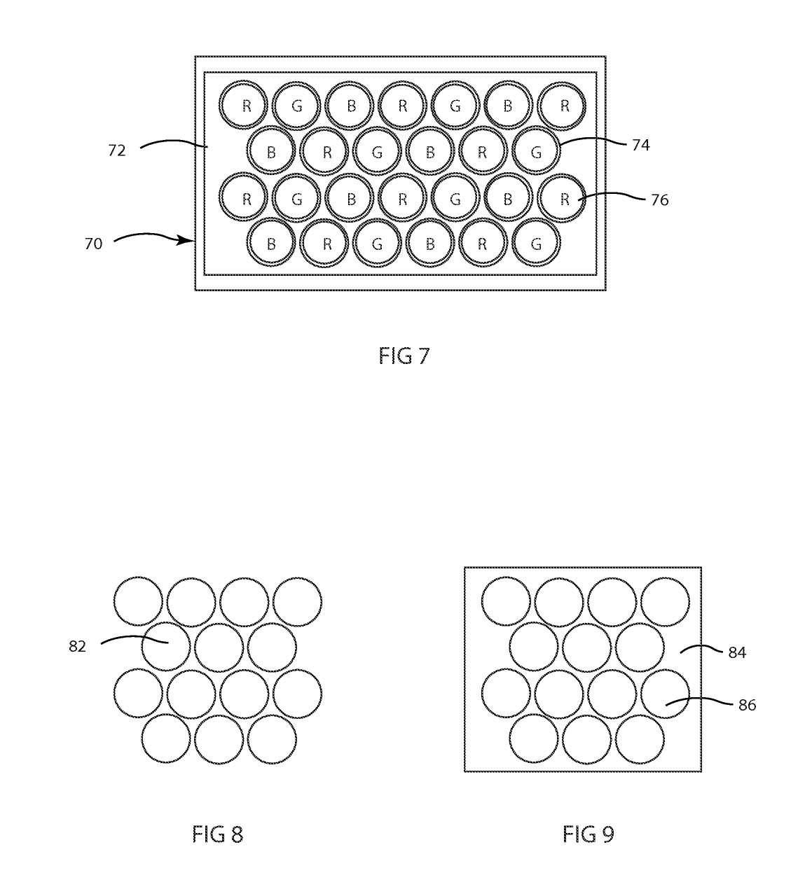

FIG. 7 illustrates the output panel 72 of an embodiment 70 of the invention. LEDs 74 each have an individual associated optical system 76 comprising lenses as described above in FIGS. 5 and 6. These lens systems may comprise individual lens elements 82 as shown in FIG. 8 or may be an array of lenses 86 molded in a single sheet 84 as illustrated in FIG. 9. Although the arrays of LEDs 74 and lenses 86 are illustrated as rectangular the invention is not so limited and the arrays may be any shape including but not limited to round, square, rectangular, and hexagonal. Although the figures shown here are of an embodiment with wash optics the invention is not so limited and the light output from the optical system may be imaging where a focused or defocused image is projected, or non-imaging where a diffuse soft edged light beam is produced, without detracting from the spirit of the invention. The invention may be used as a beam angle control system with optical systems commonly known as spot, wash, beam or other optical systems known in the art.

While the disclosure has been described with respect to a limited number of embodiments, those skilled in the art, having benefit of this disclosure, will appreciate that other embodiments may be devised which do not depart from the scope of the disclosure as disclosed herein. The disclosure has been described in detail, it should be understood that various changes, substitutions and alterations can be made hereto without departing from the spirit and scope of the disclosure.

What is claimed is:

1. An automated luminaire comprising:
a plurality of LED light sources where the LEDs have a primary optics lens element and are mounted in a reflector thereby generating a light beam, with a directional axis, which is directed toward a
Captured by a second lens element which is movably mounted the move in a path generally parallel with the LED axis and a third lens element which is also movably mounted to move in a path generally parallel with the LED axis and a fourth lens element with if fixed relative to the LED source.
Where the second, third and fourth lens form a zooming function whereby the angle of the light beam can be varied by moving the second and/or third Lens elements.

2. The automated luminaire of claim 1 where the second third and fourth lenses form achromatic lens which generally varies the beam angle of the light equivalently regardless of its wavelength within the visible range.

3. The automated luminaire of claim 1 where the lens element(s) are formed of more than one lens.

4. The automatic luminaire of claim 1 wherein one of the lens elements is biconvex.

5. The automatic luminaire of claim 4 wherein two of the lens elements are biconvex.

6. The automatic luminaire of claim 5 where three of the lens elements are biconvex.

7. An automated luminaire comprising:
a plurality of LED light sources where the LEDs have a primary optics lens element and are mounted in a reflector thereby generating a light beam, with a directional axis, which is directed toward
an achromatic zoom lens array comprised two lens elements which are movably mounted to move in a path generally parallel with the LED axis and a
lens element which is fixed in position relative to the LED source.

8. The automated luminaire of claim 7 where the two movable lens elements are mounted between the LED source and the fixed lens element.

9. The automated luminaire of claim 8 wherein a lens element is comprised of a plurality of lenses.
